(19) United States
(12) Patent Application Publication
(10) Pub. No.: US 2008/0019323 A1
(43) Pub. Date: Jan. 24, 2008

(54) Sgsn And Ggsn Integration

(75) Inventors: Jan Backman, Kärna (SE); Ann-Christine Sander, Vastra Frolunda (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/577,533

(22) PCT Filed: Oct. 19, 2004
(86) PCT No.: PCT/SE04/01501

§ 371 Date: Apr. 19, 2007

(51) Int. Cl. H04B 7/216

(52) U.S. Cl. 370/335

(57) ABSTRACT

A combined GGSN and SGSN Gateway GPRS Support Node has been disclosed com-prising at least one application unit comprising: SGSN user plane functionality, serving node user plane functionality, SU; SGSN control plane activation functionality, serving node control plane functionality, SC; GGSN user plane functionality, gateway node user plane functionality, GU, and GGSN control plane functionality, gateway node control plane functionality, GC. According to one aspect SGSN user plane functionality (SU); SGSN control plane functionality (SC); GGSN user plane functionality (GU), and GGSN control plane functionality (GC) of a given application unit (AU) is allocated to one given mobile terminal. An embodiment of the combined node (CGSN) comprises at least an internal communication bus (IB) for communicating between the application units (AU), whereby signaling between the application units on the internal communication bus are not making use of the GTP protocol.

### FIELD OF THE INVENTION

The present invention relates to the field of core network components in radio access supported packet data networks. More specifically the invention relates to GPRS (General Packet Radio Standard), which is a packet based technology for wireless access systems, i.e. GSM and UMTS, and core components SGSN (Serving GPRS Support Node) and GGSN (Gateway GPRS Support Node). More particularly, the present invention relates to various aspects of co-located SGSN and GGSN functionalities, i.e. implementations in one physical node comprising both SGSN and GGSN functionality.

### BACKGROUND OF THE INVENTION

A common packet domain Core Network is used for both GSM and UMTS has for instance been specified by the 3'rd generation partnership project (3GPP) in technical specification, 3G TS 23.060 v3.4.0 (2000-07). More recent versions have been issued subsequently.

The structure and functions, such as the specified PDP context activation transmission has been explained in WO02/41592. FIG. 1 summarizes that in order to communicate GPRS data to/from a mobile terminal, the mobile terminal first “attach” to a SGSN, subsequently an IP address is assigned to the mobile station according to the “PDP context procedure” and finally the “payload” data can be transmitted from the Internet to the mobile station.

According to the 3GPP standardization, signaling between the SGSN/GGSN nodes is performed via the vendor independent GTP protocol.

It should be noted that the SGSN, GGSN and CGSN nodes can be physically deployed in many ways. It is understood that a given site providing mobile services may have a SGSN but not necessarily a GGSN. The SGSN of a given site may for instance address the Internet through the GGSN of another site.

The CGSN

As pointed out in WO02/41592, the SGSN and GGSN functionalities may be combined in the same physical node, or they may reside in different physical nodes. At the time of filing the present application Ericsson provides a product denoted CGSN which basically constitutes a SGSN and GGSN co-located in the same rack. The current CGSN product comprises a GGSN specific part and a SGSN specific part, namely GGSN network cards for performing GGSN functionality, such as providing connectivity to Internet based services, and SGSN network cards for performing SGSN functionality, such as serving as a connectivity point to a radio base station (RBS). This has been illustrated in FIGS. 2 and 5, showing various aspects of the current Ericsson CGSN. Each respective SGSN/GGSN specific part comprises a GTP implementation, GTBI, a PDP context handling application, and a mobile station database, DBS, DBG. The GGSN specific database comprises mobile station specific information pertaining to Internet based services, such as Radius settings, while the SGSN specific mobile station specific database comprises other information such as bases station locality etc. Hence, in the existing CGSN implementation, the applications running on the nodes are separated, i.e. the SGSN application “does not know about” the GGSN application and vice versa. The content of the two SGSN and GGSN specific databases comprises some redundant information relating to the same given mobile station, but comprises also material, which is non-redundant. As concerns the common fields of the databases relating to the same given mobile station, updates to bring data in compliance with the most recent changes are off course required whenever there is a change in data content. The GGSN and SGSN network cards in the CGSN communicate over the GTP protocol. The various functional elements are provided on interface cards housing specific central processing units, CPU1-CPU8, as shown in FIG. 5. The control CP_{—M1} and user plane UP_{—M1} communication path for a mobile terminal M1 has been indicated in the CGSN. The corresponding paths for a second mobile terminal M2 has been shown.

From the viewpoint of an external GGSN or GGSN node, the co-located GGSN specific parts and the SGSN specific parts appears like separate entities that are separately addressable via IP addresses, hence the co-located SGSN and GGSN nodes appear as “normal” , i.e. 3GPP standardized separate nodes. However, from the viewpoint of the operation and maintenance interface, OSS, the Ericsson CGSN product appears as “one” product.

In FIG. 2, a diagram for the Ericsson CGSN node has been shown in more detail, comprising:

Gn Router (GnR)

A router PIU (Plug In Unit) directly connected to the Gn interface. In other words, the PIU is connected to the Gn network (GPRS backbone.) The GnR works as a normal router. Looking at the GSNs from the outside the two Gn router PIUs are two separate routers, where each router runs its own protocol stack. The O&M traffic in CGSN is handled by the GnRs.

Gn Application (GnA)

The Gn applications have been separated into those which handle user traffic, GnA-U and those who handle control traffic, GnA-C. The control and user plane PIUs can through the Gn router PIUs communicate with hosts on the Gn network (GPRS backbone). GTP encapsulation is an example of GnA functionality. In GGSN/CGSN, the GnA may co-exist with GiA on the same PIU depending on configuration. A GnA-U interface is provided for each respective SGSN and GGSN parts.

Gi Router PIU (GiR)

A router PIU directly connected to the Gi interface. In other words, the PIU is connected to a Gi network (Corporate Network or ISP.) The Gi router PIU handles both normal IP routing and APN routing. A Gi router PIU has means for connecting to several external networks that have colliding private IP addresses. Looking at the GGSN from the outside the two Gi router PIUs are two separate routers, where each router runs its own protocol stack.

Gi Application (GiA)

The GiA can through the Gi router PIUs communicate with hosts on the Gi network (Corporate Network or Internet.) The ISP device is for example a Gi Application. The Gi Application has usual router functionality. In GGSN/CGSN, the GiA may co-exist with GnA on the same PIU depending on configuration.

NCB (Node Control Board). It is possible to access other GPBs via this Plug-In Unit. There is a passive NCB PIU that automatically takes over if the active NCB PIU fails.

SS7 FE/BE

The SS7 FE module provides E1/T1 connectivity for Gr, Gs and Gd. The SS7 BE provides the SS7 stack and process SS7 information. The FE and BE module may co-exist on the same PIU.

PDP Context Activation in the CGSN

The interaction diagram in FIG. 3 shows the signaling of the PDP Context Activation in the CGSN.

1 An “Activate PDP Context Request” is received from the MS via the BSC (NS FR). The request is processed by the GnA-C the MS belongs to (where its MM information is stored).

2 To find the associated GGSN, a DNS query is sent to the Caching-Only DNS on NCB (i.e. the SGSN internal DNS). (Steps 2-7 are performed outside the CGSN and are not illustrated).

3 If the Caching-only DNS on the NCB does not have matching GGSN, it will forward the query (iteratively) to the external DNS via the GomR using the OM VIP on the NCB as the source IP address.

4 The GomR forwards the DNS query to the external DNS.

5 The GomR receives the DNS reply that contains a list of GGSN IP addresses.

6 The GomR forwards the DNS reply to the NCB, using a forwarding table for the incoming DNS reply destined to the OM VIP. If the Caching-only DNS on the NCB had a matching entry, round-robin (rotation) is performed on the list of GGSN IP addresses before it is sent to the GnA-C.

7 The DNS Reply is received by the GnA-C from the NCB. A GnA-U for payload is selected and the GTP-U VIP for that PIU is retrieved.

8 The “Create PDP Context Request” is sent to the GGSN using the GTP-C VIP on the GnA-C as source IP address. There are two GTP VIP addresses included in the message —one for control traffic and the one for downlink payload. Further, two TEIDs (for GTPv0, a TID, a Flow Label Data I and a Flow Label Signaling are sent instead of TEIDs) are included in the message, one for control traffic and one for downlink payload.

These TEIDs (for GTPv0; TID, Flow Label Data I, for downlink signaling, and Flow Label Signaling, for downlink payload, are sent instead of TEIDs) are generated by the SGSN.

9 GnR forwards the “Create PDP Context Request” to the Gn network (GPRS backbone).

10 In the “Create PDP Context Response” the GGSN includes (in a similar manner) two IP addresses—one for control and one for uplink payload—plus one IP address for the MS (unless it has a static IP address configured), and two TEIDs (for GTPv0; TID, Flow Label Data I and Flow Label Signaling are received instead of TEIDs).

11 The GnR uses a forwarding table to find the correct GnA-C to forward the incoming Response to.

12 An “Activate PDP Context Accept” is sent to the MS including its assigned IP address.

GSM Payload in the User Plane

In FIG. 4, the procedure for a GSM payload transmission in the CGSN has been illustrated:

1 The MS transmits an IP packet destined for an Internet host. The IP packet is transported to the SGSN over L2 protocols.

2 The GnA encapsulates the IP packet in a GTP/UDP/IP header. It is then forwarded to the GnR.

3 The GnR uses a forwarding table to route the incoming GTP packet based on the GTP VIP address to the appropriate GnA.

(In a CGSN, the GTP packet is re-routed by the GnRs to the GGSN part.)

4 Subsequently, the GnA removes the GTP/UDP/IP header and the original IP packet is transported by use of an Internal L2 tunnel to forward the IP packet to the GiR 5. The receiving GiR forwards the packet towards the Internet host. The IP packet is routed through the ISP network and Internet before it finally ends up at the Internet host.

Some drawbacks with existing separate SGSN and GGSN and CGSN implementations are that:

It is difficult to re-use information between the SGSN and GGSN applications, since it requires additions (vendor specific, or not) to the GTP protocol.

There is a substantial tunneling overhead between the SGSN and GGSN; this means that there is a substantial end-user bandwidth loss. This problem will aggravate if or when VoIP becomes widely accepted.

### SUMMARY OF THE INVENTION

The invention seeks to reduce the signaling overhead and the associated transmission delay in a combined node.

This object has been accomplished by claim 1.

It is another object to set forth a method for an efficient allocation of resources in a combined node.

This object has been accomplished by the method according to claim 8.

It is another object to set forth a process for efficient control plane signaling in a combined node.

This object has been accomplished by claim 13.

It is another object to set forth a process for efficient user plane signaling in a combined node.

This object has been accomplished by claim 14.

Further advantages will appear from the following detailed description of the invention.

### BRIEF DESCRIPTION OF THE DRAWINGS

FIG. 1 shows prior art Attach, activate PDP context and payload signaling,

FIG. 2 shows a known CGSN architecture sold by Ericsson,

FIG. 3 shows a control plane routine in the GGSN node according to FIG. 2,

FIG. 4 shows a payload being transmitted in the CGSN of FIG. 2,

FIG. 5 shows the control plane (CP) and user plane (UP) resource allocations for two mobile terminals MT1 and MT2 in the CGSN of FIG. 2,

FIG. 6 shows a preferred embodiment of the invention, in which exemplary control plane (CP) and user plane (UP) resource allocations for two mobile terminals MT1 and MT2 in the CGSN are indicated,

FIG. 7 shows a first embodiment of an application unit, AU, according to the invention,

FIG. 8 shows second and third embodiments of application units according to the invention,

FIG. 9 is a schematic representation of a resource allocation method according to the invention,

FIG. 10 illustrates a control plane routine in the CGSN node according to a preferred embodiment of the invention,

FIG. 11 illustrates a payload being transmitted in the CGSN of the preferred embodiment of the invention,

FIG. 12 shows a control plane activation for the first application unit, and

FIG. 13 shows a payload plane signaling for the first application unit.

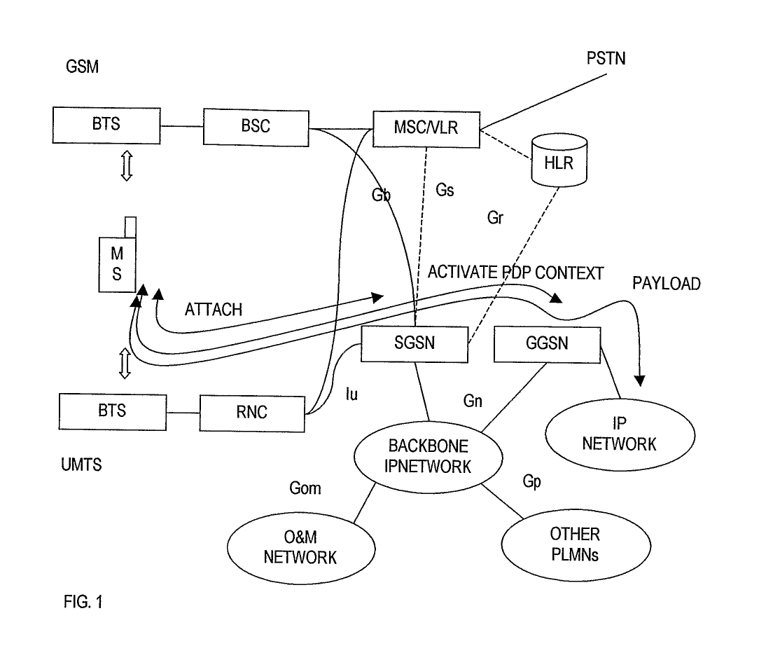

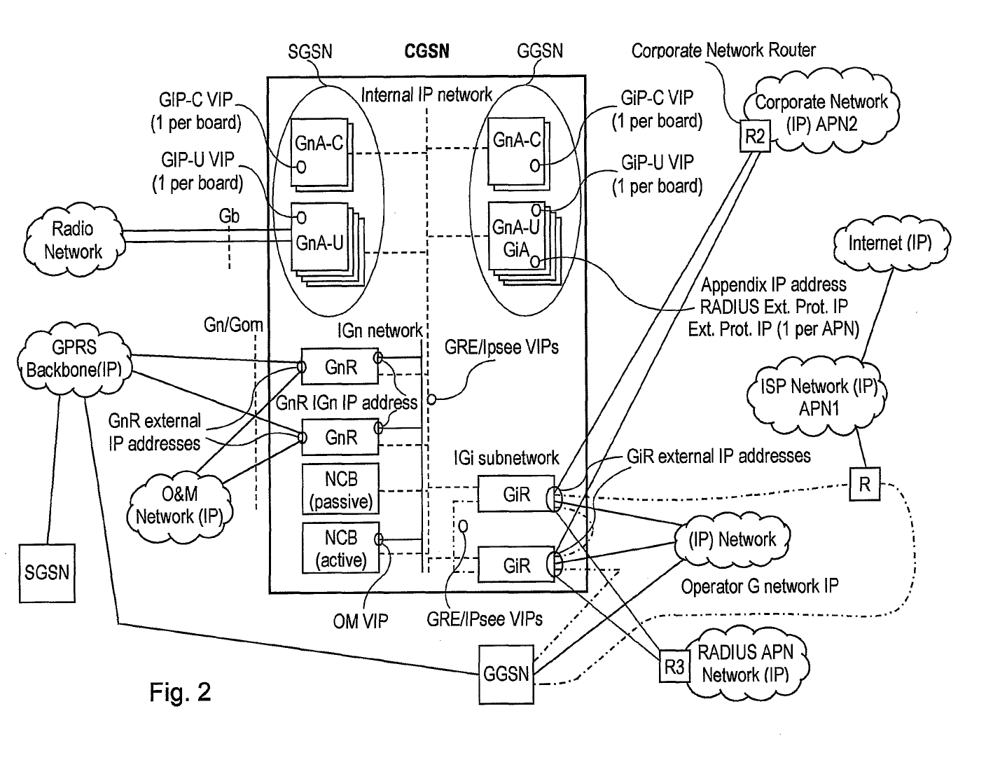

### DETAILED DESCRIPTION OF PREFERRED EMBODIMENTS OF THE INVENTION

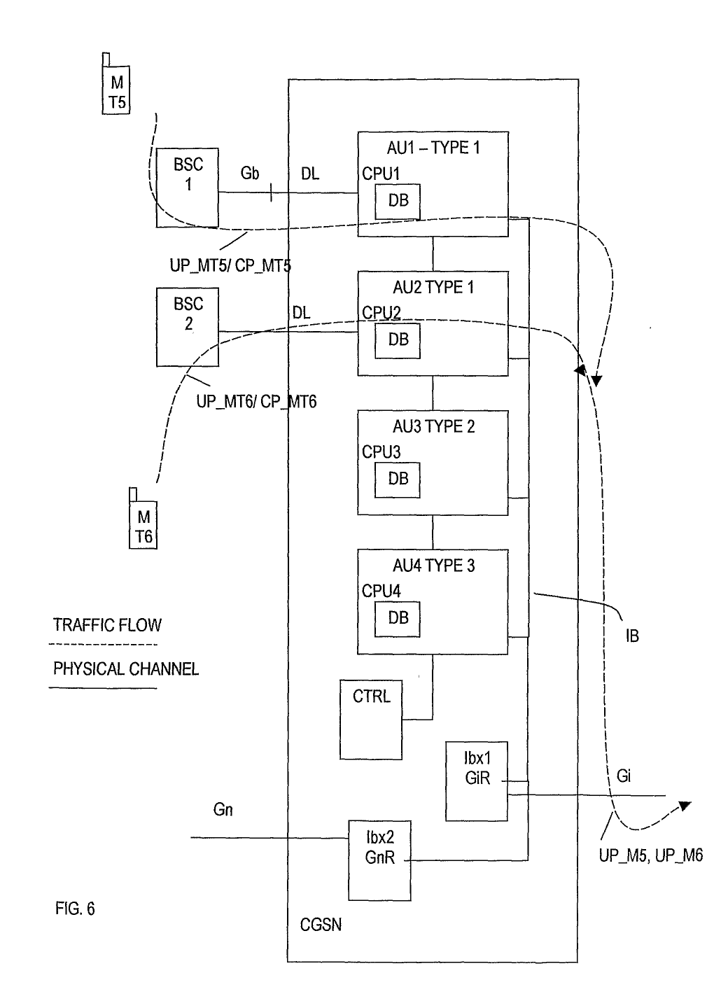

In FIG. 6, a preferred embodiment of a co-located SGSN/GGSN (CGSN) node according to the invention has been illustrated.

The CGSN comprises a plurality of application units, AU1-AU4, an internal bus, IB, a first interface board IBx1 accommodating a GiR router, GiR, offering a Gn interface and a second interface board, IBx2, accommodating a GnR router, offering a Gi interface. According to one embodiment the CGSN moreover comprises control unit, CTRL, for monitoring and allocating resources. Alternatively, the control functionality of the control unit may be distributed in each application unit (not shown).

According to a further embodiment of the CGSN node according to the invention the Ibx2 interface board providing the Gn interface may be omitted from the CGSN.

The application units AU1 and AU2 are coupled to base station controllers BSC1 and BSC2 over respective direct links, DL, forming Gb interfaces.

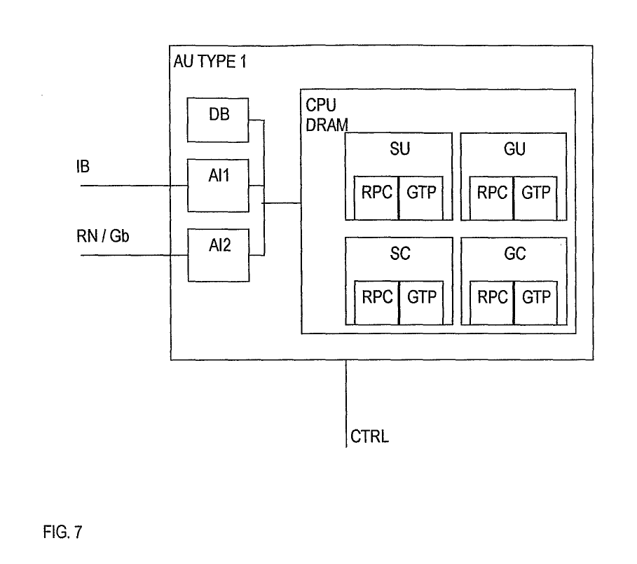

In FIG. 7, a first embodiment of the application unit, denoted type 1, according to the invention has been shown in further detail. The application unit comprises a database, DB, a first application unit interface, AI1, providing connectivity to the internal bus, IB, a second application interface AI2, constituting a Gb interface to the radio network. The type 1 application unit comprises: SGSN user plane functionality, SU; SGSN control plane functionality, SC; GGSN user plane functionality, GU, and GGSN control plane functionality, GC. Each individual functionality of the above application unit are all available to at least one given mobile terminal such that the resources of a given application unit may be allocated to given mobile terminals in an arbitrary manner. The data which is necessary for the given call/session associated with a given mobile terminal in the radio network is stored in the database, DB. According to the invention, the serving node user plane functionality, SU, serving node control plane functionality, SC, gateway node user plane functionality, GU and gateway node control plane functionality, GC are software applications running on the application unit, AU. The application unit according to the preferred embodiment according to FIG. 7 according to the invention may comprise a central processing unit (CPU) and a random access memory (DRAM) for executing the above applications.

Inter application unit communication—within the CGSN—may be performed by processor calls, e.g. remote procedure calls (RPC) from a central processing unit of a first unit to another central processing unit of another unit. Alternatively, inter application unit communication may be performed by means of GTP tunnels. Both means have been indicated as being part of the software application running in the CPU of the application unit in FIG. 7. According to one advantageous embodiment of the invention, no GTP interfaces are needed for intra-CGSN traffic over the internal communication bus.

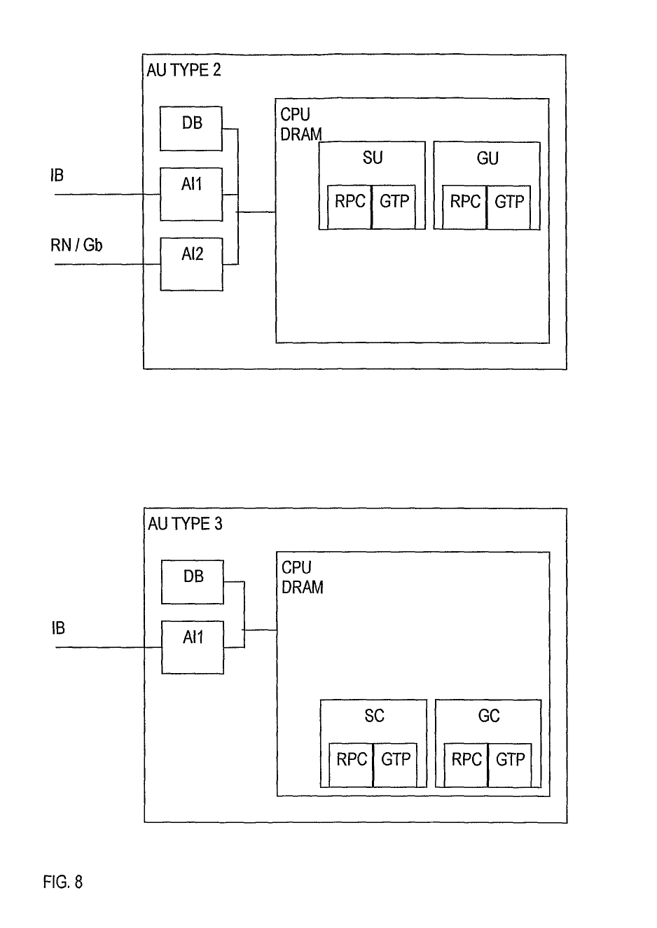

A second type of application unit, type 2, has been indicated in FIG. 8, which is identical to type 1, except for not having the serving node control plane functionality, SC and gateway node control plane functionality, GC. A third type of application unit, type 3, has moreover been indicated in FIG. 8, which is identical to the first type, except not having serving node user plane functionality, SU and gateway node user plane functionality, GU and not having a Gb interface. The second and third types cooperate to provide the desired functionalities.

According to one embodiment of the CGSN according the invention as shown in FIG. 6, there may be provided two type-1 application units, AU1 and AU2, a type-2, application unit, AU3, and a type-3 application unit, AU4. Other combinations are possible; one practical application may for instance consist of four type-2 application units and four type-3 application units. Still another embodiment may comprise four type 1 application units.

As mentioned above, the resources of each application unit may be allocated to given mobile terminals in an arbitrary manner, which shall be exemplified by the table below: For instance, a mobile terminal MT1, may be allocated resources: SGSN user plane handling on AU1, while GGSN user plane handling, gateway node user plane functionality, GU, SGSN and GGSN control plane handling on application unit AU2 (MT1).

Other possible configurations appear for terminals MT2 to MT6 in table 1.

TABLE 1

| | AU1 | AU1 | AU1 | AU1 | AU2 | AU2 | AU2 | AU2 |
|---|---|---|---|---|---|---|---|---|
| | SU | GU | SC | GC | SU | GU | SC | GC |
| MT1 | X | | | | | X | X | X |
| MT2 | | X | X | | X | | | X |
| MT3 | X | X | | | | | X | X |
| MT4 | | | X | X | X | X | | |
| MT5 | X | X | X | X | | | | |
| MT6 | | | | | X | X | X | X |

Two preferred allocations have been shown for mobile terminals MT5 and MT6 in table 1 and FIG. 6. According to this allocation, all user plane, UP, and control plane, CP, signaling for both the SGSN functionality and the GGSN functionality for a given mobile terminal are gathered on a single respective application unit, AU.

In this manner, the data necessary for the given PDP contexts for each terminal is gathered on a single database on each application unit. This leads to a reduction of redundant data, which hitherto had been distributed on several application units. Moreover, since the databases are located on the application units, the allocation ensures quicker access to data. Further advantages shall be dealt with later.

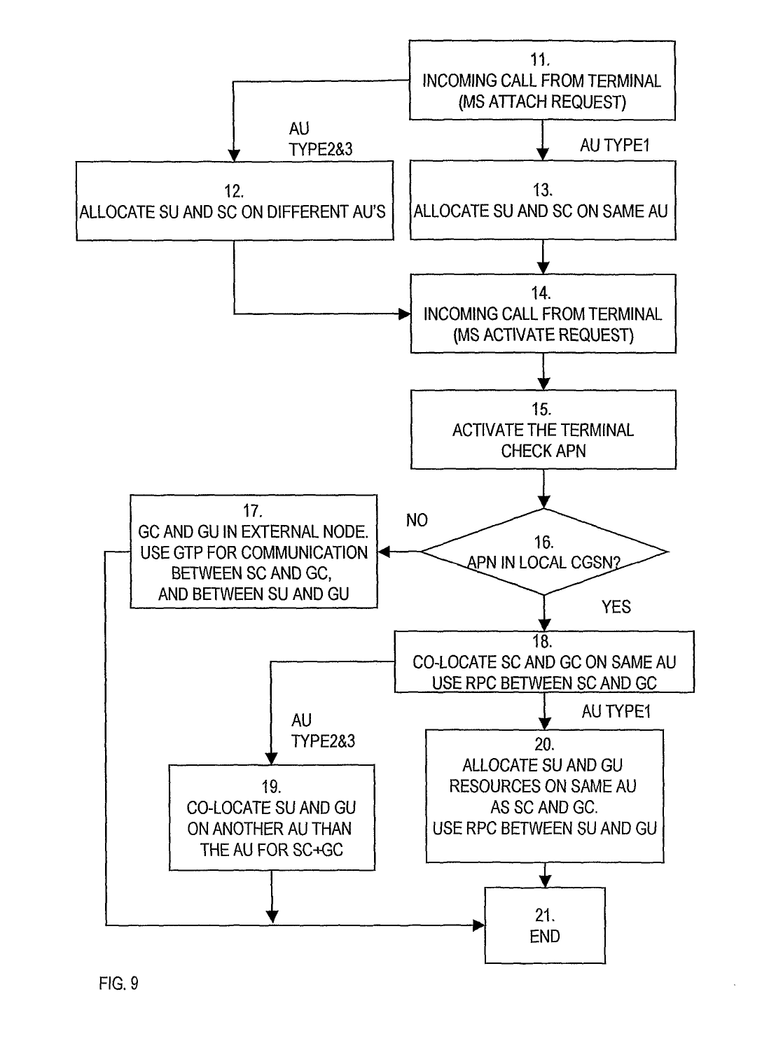

In FIG. 9, a preferred routine for allocating the resources of the prevalent application units to mobile terminals connected to the mobile radio network is shown. The carrying out of this routine may be performed by the control unit, CTRL, shown in FIG. 6 or alternatively by a distributed control functionality (not shown) of each application unit.

Step 11—a call is received from a terminal in a local CGSN. For instance, the call may be received on the Gb interface as shown in FIG. 6 for mobile terminal MT5. (The serving node control plane functionality, SC functionality (confer type 1 or type 3 application unit AU) of the given application unit, AU, receiving the call over the Gb interface on a direct link DL is assigned for the given call. The MS sends an Attach Request to SGSN.

The Attach Request is received on a certain serving node user plane functionality, SU, which will handle all traffic to/from this MT.

The control unit (CTRL) of the SGSN parts may use the identifiers of the MT (IMTI, TLLI etc) to select which serving node control plane functionality, SC in the CGSN parts that shall handle a certain subscriber.

Step 12—If the application unit AU is not type 1:

Serving node user plane functionality, SU and serving node control plane functionality, SC are located on different application unit AU.

Step 13—If the application unit AU is of type 1:

Serving node user plane functionality, SU and serving node control plane functionality, SC, are co-located on the same application unit AU.

Step 14—The serving node user plane functionality, SU forwards the Attach Request to the chosen serving node control plane functionality, SC. The serving node control plane functionality, SC processes the message and gets subscription data from HLR, which is stored in the database on the serving node control plane functionality, SC. The serving node control plane functionality, SC forwards an Attach Accept to the serving node user plane functionality, SU, together with necessary information. The serving node user plane functionality, SU will send the Attach Accept to the MT, and it will also store relevant data in its database.

The gateway control plane functionality, GC and gateway node user plane functionality, GU) are not involved in the Attach handling.

Step 15—The mobile terminal MT sends an Activate Request to the SGSN part. The Activate Request is received on the same serving node user plane functionality, SU as the Attach Request.

The serving node user plane functionality, SU has stored in its database which serving node control plane functionality, SC that handles this MT. The Activate Request is forwarded to this serving node control plane functionality, SC.

The Activate Request contains an APN (Access Point Name), and the serving node control plane functionality, SC resolves this APN by using DNS servers (internal or external to the CGSN).

The resolution logic results in an IP-address of a GGSN.

Step 16—The serving node control plane functionality, SC determines if this IP address points at the GGSN part of this CGSN, or if it is an IP-address of an external GGSN.

Step 17—If the IP-address points at an external GGSN:

The gateway node control plane functionality, GC and gateway node user plane functionality, GU for this MT cannot be allocated in the CGSN.

GTP is to be used for communication to the GGSN, both for control plane CP and user plane UP.

The serving node control plane functionality, SC constructs a GTP message, Create PDP Context Request, which is forwarded to the GnR, which in its turn forwards it to the GGSN.

Step 18—If the IP-address points at the internal GGSN:

The gateway node control plane functionality, GC and gateway node user plane functionality, GU for this MT can be allocated in the local CGSN. The gateway node control plane functionality, GC is co-located on the same application unit AU as the serving node control plane functionality, SC.

GTP is not needed between serving node control plane functionality, SC and gateway node control plane functionality, GC. RPC or a similar mechanism can be used for communication between the gateway node control plane functionality, GC and the serving node control plane functional GTP is not needed

Step 19—If the application unit AU is not type 1: The gateway user plane functionality GU is co-located on the same application unit AU as the serving node user plane functionality SU, but not on the same application unit AU as the serving node control plane functionality SC and gateway node control plane functionality GC. All communication between gateway control plane functionality GC and gateway user plane functionality GU is non-GTP, irrespective of application unit AU type, irrespective of CGSN or not. All communication between serving node control plane functionality SC and serving node user plane functionality SU is non-GTP, irrespective of application unit AU type, irrespective of CGSN or not.

Step 20—If the application unit AU is type 1: The gateway control plane functionality GC and the gateway user plane functionality GU for this mobile terminal MT can be allocated in the present CGSN. The gateway control plane functionality GC and gateway user plane functionality GU is co-located on the same application unit AU as the serving node control plane functionality SC and the serving node user plane functionality SU. GTP is not needed.

Control and User Plane Signaling of Preferred Embodiment

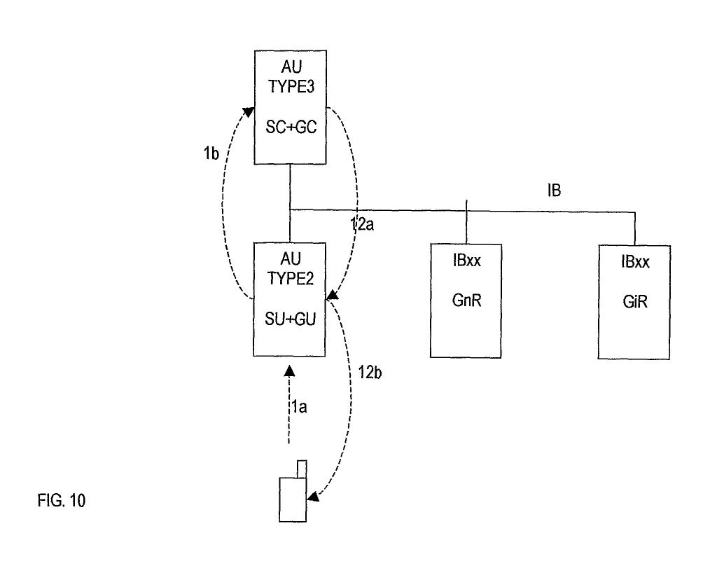

In FIG. 10, an exemplary control plane signaling for a PDP context activation according to the invention has been shown for an allocation consisting of type-2 and type-3 application units.

The following steps are carried out:

1a A PDP context activation is received at application unit AU type-2;

1b the PDP context activation is transmitted to application unit AU type-3,

12a an “Activate PDP Context Accept” message including the assigned IP address is transmitted from application unit AU type-3 to application unit AU type-2,

12b the PDP context activation is forwarded to the mobile terminal.

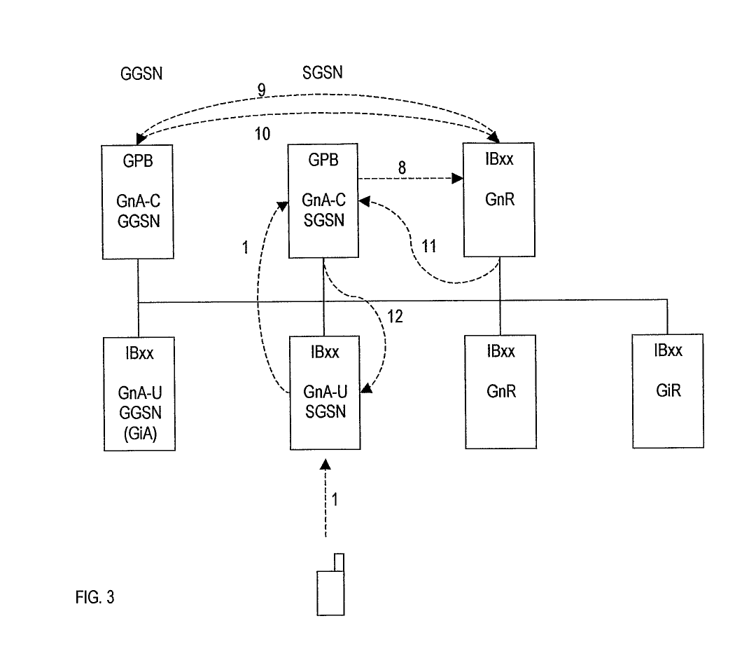

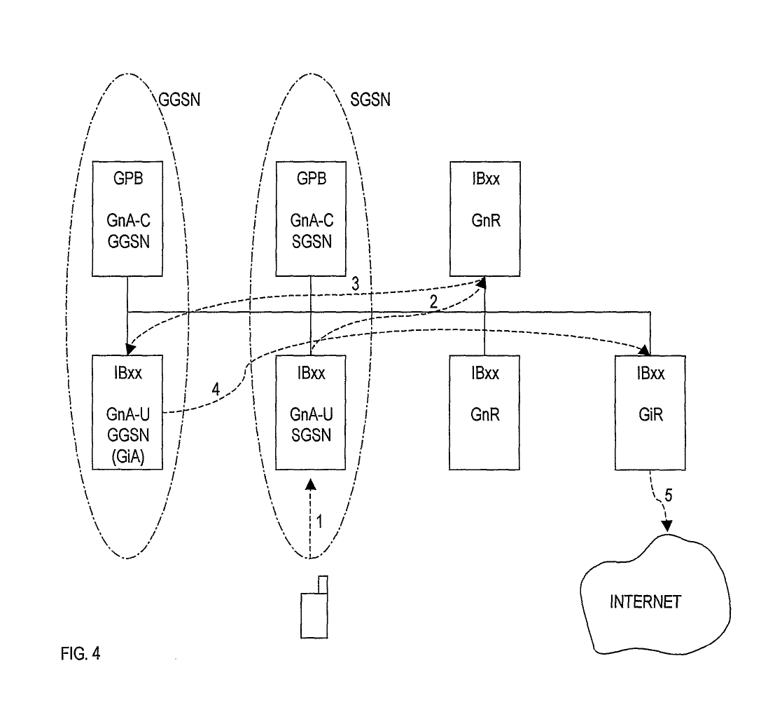

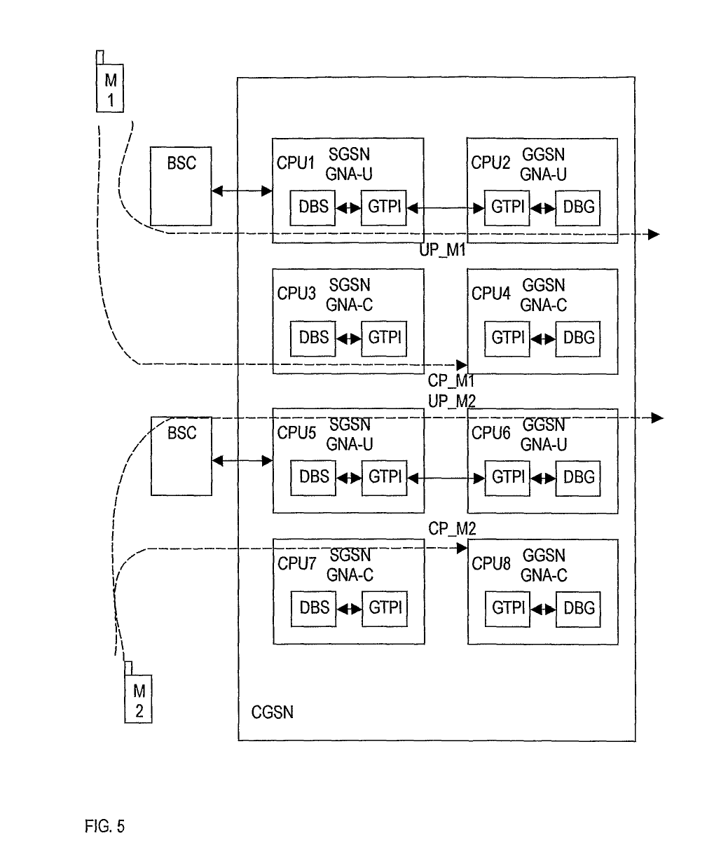

Please note that the reference signs corresponding to the prior art procedure of FIG. 3 has been retained. It is moreover noted that if all functionalities are collocated on the same type-1 application unit, the signaling occurs internally in the application unit.

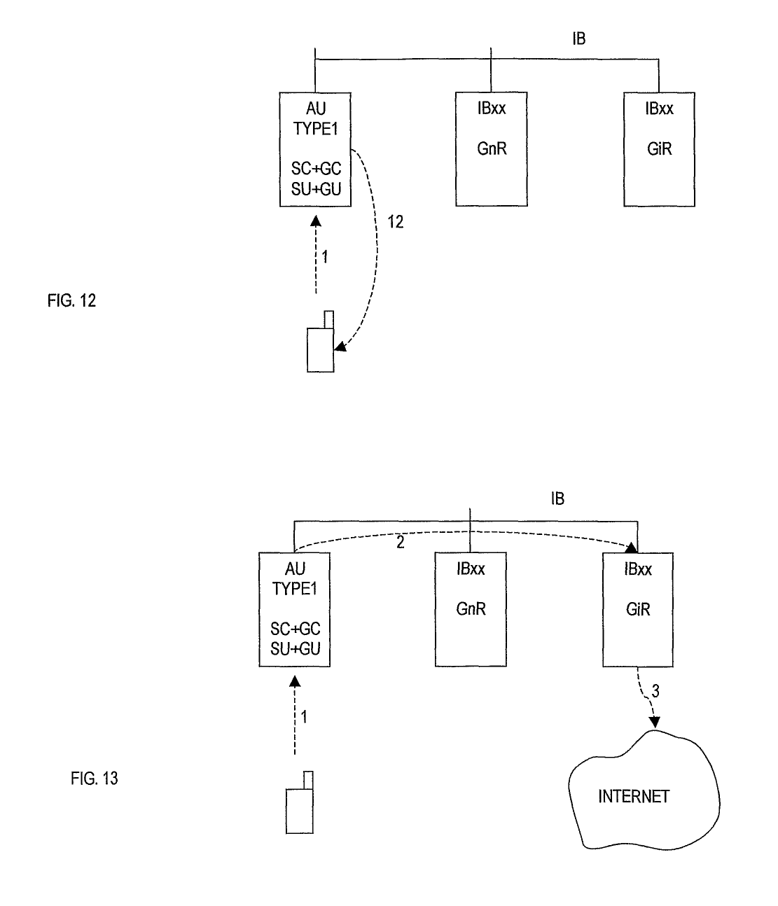

In FIG. 12, the corresponding steps for the control plane activation for a type 1 application unit have been shown.

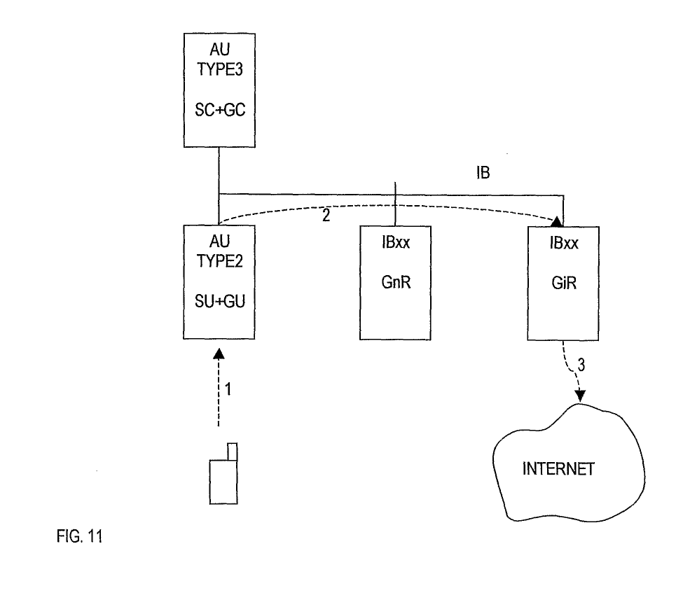

In FIG. 11, the steps carried out for performing a GSM payload transmission from the mobile station to a server on the Internet has been shown:

1 The MT transmits an IP packet destined for an Internet host, the packet is received on the GnA-U interface in the “SGSN part” of the CGSN according to the invention.

2 The packet is directly forwarded to the GiR router

3 The packet is transmitted to the host on the Internet

In FIG. 13 the corresponding steps for the user plane activation for the type 1 application unit has been shown.

Advantages of the Various Embodiments of the Invention

The present invention utilizes resources (memory, processor utilization etc) more efficiently, which leads to less manufacturing costs. It moreover appears that there will be lower delays in both control plane and user plane signaling, since packets are handled internally and therefore are not experiencing transmission delays over Gn. Packets also enjoy a smaller risk of being dropped.

One aspect of the present invention deals more effectively with error situations by providing better network availability for a user by using the same CPU(s) for the SGSN and GGSN functionality of a call.

According to the invention, network redundancy on the Iu/Gb interface (SGSN pooling) is facilitated, such that there is no need to have yet another mobility interface within an operators' network. I.e. the Gn interface is unnecessary, only the Gp interface is needed for access to other GPRS networks. If and when pooling is introduced towards the RNC and BSC, change of SGSN will be very rare. This means that the Gn interface typically gives a flexibility that is not needed.

The current evolution of having more charging functionality in the GGSN means that more information needs to be signaled from the SGSN to the GGSN. This task is simplified by the present invention since the SGSN and GGSN databases reside on the same CPU, which makes a more efficient data sharing possible between SGSN and GGSN. In the existing GPRS networks it also requires proprietary extensions to be able to share non-standardized information between SGSN and GGSN. The present invention deals more effectively with this situation by providing better network availability for a user by using the same CPU(s) for the SGSN and GGSN functionality of a call. With less spreading of users over different CPUs, fewer users are affected when CPU's crash due to software or hardware errors. Clean up after errors are also easier accomplished than in known solutions.

From an operator perspective, the network dimensioning is rendered easier since it involves fewer interfaces and fewer nodes of various performance levels. Currently, operators tend to have the same APN on all GGSNs, especially for services like WAP. This means that the Gn interface is typically not necessary.

Short-lived PDP-contexts are currently a trend. This incurs excessive non end-user traffic signaling over the Gn interface. Without the Gn interface it is not necessary to dimension for this case.

The use of SGSN database information in GGSN and vice versa additionally leads to the following improvements/possibilities:

FBC (Flexible Bearer Charging) in GGSN can have access to packet loss information for a PDP context from SGSN; this enables more accurate charging in GGSN. See also charging above.

The invention makes it possible to send ICMP host unreachable messages from GGSN functionalities when the logical SGSN has lost contact with the MT, which then implicitly tells the sending party that the IP address of the MT currently is not reachable.

Positioning services can be used by the GGSN (GU+gateway node control plane functionality, GC) and thereby location based charging combined with FBC (Flexible Bearer Charging) in the GGSN is possible. It is made possible since the gateway node control plane functionality, GC has access to the serving node control plane functionality, SC DB on the same AI, and the GGSN can therefore use the MT location knowledge of the SGSN.

Network initiated PDP context activation is much easier to implement, since the GGSN has access to the SGSN (DB) without using it as a relay for queries. The GGSN can also determine if the MT to be activated is residing in the same CGSN, without sending a node-external GTP query. It is currently a problem if a certain PDP Context is lost in a GGSN, while it remains in the SGSN. This can occur in different error situations, and can sometimes give a large number of “hanging” PDP contexts in the GGSN. This problem is removed by having the serving node control plane functionality, SC and gateway node control plane functionality, GC sharing the same database DB, which means that if the SGSN PDP Context is removed, also the GGSN counterpart is automatically removed as well.

Abbreviations

APN Access Point Name

AQM Active Queue Management

CGSN Combined GPRS Support Node

FBC Flexible Bearer Charging

GC GGSN control plane functionality

GGSN Gateway GPRS Support Node

GPRS General Packet Radio Service

GSM Generic System for Mobile communication

GTP GPRS Tunneling Protocol

GU GGSN user plane functionality

ICMP Internet Control Message Protocol

IP Internet Protocol

MSS Maximum Segment Size

MT Mobile Terminal

NCS Node Control System

RNC Radio Network Controller

SC SGSN control plane functionality

SGSN Serving GPRS Support Node

SS7 Signaling System #7

SU SGSN user plane functionality

TCP Transmission Control Protocol

UMTS Universal Mobile Telephony System

WPP Wireless Packet Platform

1. Combined node comprising, at least one application unit, a routing unit providing a network interface to at least the Internet, whereby
the at least one application unit comprises a serving node user plane functionality; and/or a serving node control plane functionality; and/or a gateway node user plane functionality, and/or a gateway node control plane functionality, each individual functionality of an application unit being assignable to at least one given mobile terminal such that the resources of a given application unit may be allocated to given mobile terminals in an arbitrary manner,
each application unit moreover comprising a database which comprises data necessary for the given call/session associated with a given mobile terminal in the radio network.

2. Combined node according to claim 1, comprising at least two application units
the combined node comprises at least an internal communication bus for communicating between the application units, whereby signaling between the application units on the internal communication bus are not making use of the GTP protocol.

3. Combined node according to claim 1, wherein each application unit comprises at least a central processing unit and a random access memory and wherein the serving node user plane functionality, the serving node control plane functionality the gateway node user plane functionality and the gateway node control plane functionality are software applications running on at least one application unit.

4. Combined node according to claim 2. wherein inter application unit communication is performed by remote procedure calls from a central processing unit of a first application unit to the central processing unit of another application unit.

5. Combined node according to claim 2, wherein the at least one application unit comprises, an interface to the internal bus, a database and a central processing unit comprising serving node user plane functionality and gateway node user plane functionality applications.

6. Combined node according to claim 1, wherein the at least one application unit comprises, an interface to the internal bus, a database and a central processor comprising serving node control plane functionality, and gateway node control plane functionality applications.

7. Combined node according to claim 1, wherein the at least one application unit comprises, an interface to the internal bus, a database and a central processor comprising serving node user plane functionality, gateway node user plane functionality serving node control plane functionality, and gateway node control plane functionality, applications.

8. Method of allocating available resources of a given application unit (AU) in a combined node to at least one given mobile terminal, the method comprising the following steps:
receiving a call from a terminal on a given application unit,
assigning a serving node control plane functionality to the given application unit, receiving the call,
performing mobile station Attach and initiating a PDP Activation by using the serving node control plane functionality application,
performing activation,
checking whether the access point name requested by the mobile terminal, and designating a given sought service is available in the combined node, and if so
co-locate serving node control plane functionality and gateway node control plane functionality on the same application unit.

9. Method according to claim 8, wherein if the access point name requested by the mobile terminal and designating a given sought service, is not available in the combined node, allocate gateway node user plane functionality and gateway node control plane functionality in external node and use remote procedure calls for communication between serving node control plane functionality and gateway node control plane functionality and between serving node user plane functionality and gateway node user plane functionality.

10. Method according to claim 8, wherein serving node user plane functionality and gateway node user plane functionality of a given application unit is allocated to one given mobile terminal.

11. Method according to claim 8, wherein gateway node control plane functionality and serving node control plane functionality of a given application unit is allocated to one given mobile terminal.

12. Method according to claim 8, wherein serving node user plane functionality; serving node control plane functionality, gateway node user plane functionality and gateway node control plane functionality of a given application unit is allocated to one given mobile terminal.

13. Process of carrying out a control plane activation in a combined node, comprising serving node and gateway node control plane functionality, gateway node and serving node user plane functionality and a routing functionality through which access to the Internet is performed,
receiving a PDP context activation message from a mobile station on a first interface associated with an application unit providing serving node user plane functionality,
transmitting the message directly to a second interface associated with an application unit providing serving node control plane functionality,
responding the mobile station directly via the second interface by transmitting an Activate PDP Context Accept message including the assigned IP address to the mobile station.

14. Process of carrying out a GSM payload plane transport in an integrated serving node/gateway node comprising a serving node user plane functionality, SU/GU interface with serving node and gateway node user plane functionality and a routing functionality through which access to the Internet is performed
receiving an IP packet destined for an Internet host from a mobile station, on the interface associated with an application unit providing serving node user plane functionality,
forwarding the packet directly to the router,
transmitting the packet to a host on the Internet.
